(19) United States
(12) Patent Application Publication
(10) Pub. No.: US 2023/0128060 A1
(43) Pub. Date: Apr. 27, 2023

(54) COMPRESSOR

(71) Applicant: MITSUBISHI HEAVY INDUSTRIES THERMAL SYSTEMS, LTD., Tokyo (JP)

(72) Inventors: Yasunori WATANABE, Tokyo (JP); Takayuki HAGITA, Tokyo (JP); Shunsuke YAKUSHIJI, Tokyo (JP); Hideo SAHO, Tokyo (JP); Shohei TERASAKI, Tokyo (JP)

(73) Assignee: MITSUBISHI HEAVY INDUSTRIES THERMAL SYSTEMS, LTD., Tokyo (JP)

(21) Appl. No.: 17/911,857

(22) PCT Filed: Mar. 19, 2021
(86) PCT No.: PCT/JP2021/011404

§ 371 Date: Sep. 15, 2022

(30) Foreign Application Priority Data
Mar. 23, 2020 (JP) 2020-051199

(51) Int. Cl. F04B 39/00; B60H 1/32; B60H 1/00

(52) U.S. Cl. CPC F04B 39/0033; B60H 1/3204; B60H 1/00507; B60H 2001/006

(57) ABSTRACT

The objective of the present invention is to provide a compressor with which it is possible to simplify the manufacture of a soundproof cover. A compressor (1) is provided in an air conditioning device for an automobile. The compressor (1) is provided with: a main body portion which has a discharge port (12) and which compresses a refrigerant; and a soundproof cover (20) which includes a first cover (30) and a second cover (40), separate from the first cover (30), and inside which an internal space is formed, the main body portion being accommodated in the internal space. The soundproof cover (20) includes, in a part in which the first cover (30) and the second cover (40) face one another: a contacting portion (24) in which the first cover (30) and the second cover (40) are in contact with one another, thereby separating the internal space and an external space outside the soundproof cover (20); and a spaced-apart portion (25) in which the first cover (30) and the second cover (40) are separated from one another to form a first opening (26) connecting the internal space and the external space. The discharge port (12) is inserted through the first opening (26).

### TECHNICAL FIELD

The present disclosure relates to a compressor.

### BACKGROUND ART

In the related art, a technique for reducing noise generated from a compressor of an air conditioning device mounted on an automobile has been known. In order to reduce the noise generated from the compressor, there are a method of reducing a sound pressure level of noise reduction and a method of absorbing and insulating the generated noise. PTL 1 describes an electric compressor that compresses a refrigerant gas sucked from a gas-liquid separator and then discharges the refrigerant gas from a discharge pipe. A casing of the electric compressor and the gas-liquid separator are completely covered with a sound insulating cover made of a metal plate or a synthetic resin.

### CITATION LIST

### Patent Literature

[PTL 1] Japanese Unexamined Patent Application Publication No. 8-61234

### SUMMARY OF INVENTION

### Technical Problem

Incidentally, it is conceivable that the soundproof cover covering the compressor has a structure in which a plurality of parts (for example, a first part and a second part) are combined. In the case of the structure in which the plurality of parts are combined, if a gap is formed in a part where the first part and the second part face each other due to a manufacturing error or the like, sound may leak from the gap. Therefore, it is desirable that the first part and the second part are in close contact with each other at the parts facing each other. In addition, the compressor may include a connecting portion (for example, discharge pipe or the like) for connecting to an external device. In this case, the soundproof cover needs to have an opening through which the connecting portion is inserted. In a case where a gap formed between an edge of the opening and the connecting portion is large, sound may leak through the gap. Therefore, it is desirable that the opening is formed so that the gap formed between the opening and the connecting portion is small. As described above, it is desirable that the soundproof cover is formed with high accuracy at the part where the first part and the second part face each other and the part where the opening through which the connecting portion is inserted is formed. However, if there are many parts formed with high accuracy, a manufacturing step of the soundproof cover may be complicated.

The present disclosure has been made in view of such circumstances, and an objective thereof is to provide a compressor with which it is possible to simplify the manufacture of a soundproof cover.

### Solution to Problem

In order to solve the above problems, a compressor of the present disclosure adopts the following means.

A compressor according to an aspect of the present disclosure is a compressor provided in an air conditioning device for an automobile, including a main body portion that includes a connecting portion for connecting to an external device and compresses a refrigerant, and a soundproof cover that includes a first part and a second part separate from the first part, has an internal space S formed inside the soundproof cover, and accommodates the main body portion in the internal space S, in which the soundproof cover includes an abutment part that separates the internal space S from an external space outside the soundproof cover by causing the first part and the second part to abut on each other, and a spaced-apart portion that forms an opening connecting the internal space S and the external space by separating the first part and the second part from each other, in a part where the first part and the second part face each other, and the connecting portion is inserted through the opening.

### Advantageous Effects of Invention

According to the present disclosure, it is possible to simplify the manufacture of the soundproof cover.

### BRIEF DESCRIPTION OF DRAWINGS

FIG. 1 is a schematic vertical cross-sectional view illustrating a compressor according to a first embodiment of the present disclosure.

FIG. 2 is a schematic vertical cross-sectional view illustrating a state where a soundproof cover is attached to the compressor of FIG. 1.

FIG. 3 is a side view illustrating the compressor according to the first embodiment of the present disclosure.

FIG. 4 is a plan view of the compressor of FIG. 3.

FIG. 5 is a bottom view of the compressor of FIG. 3.

FIG. 6 is a schematic vertical cross-sectional view illustrating a fixed part between a bracket and a main body portion on a vehicle body side of the compressor of FIG. 3.

FIG. 7 is a graph illustrating a relationship between a density of a porous material and a noise reducing effect.

FIG. 8 is a plan view illustrating a compressor according to a second embodiment of the present disclosure.

FIG. 9 is a bottom view illustrating the compressor according to the second embodiment of the present disclosure.

### DESCRIPTION OF EMBODIMENTS

Hereinafter, an embodiment of the compressor 1 according to the present disclosure will be described with reference to the drawings.

### First Embodiment

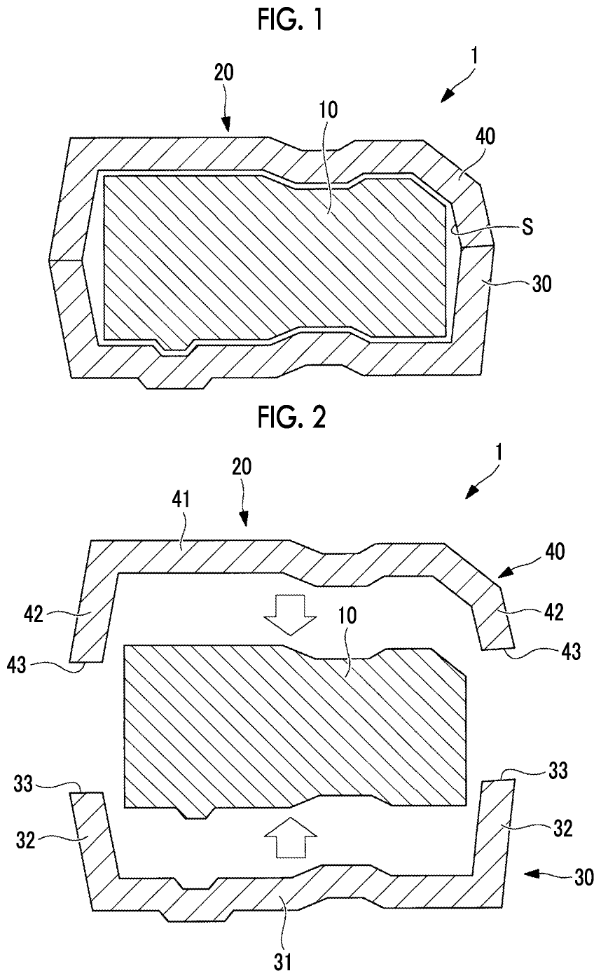

Hereinafter, the first embodiment of the present disclosure will be described with reference to FIGS. 1 to 7.

The compressor 1 according to the present embodiment is a compressor 1 used in an air conditioning device mounted on an automobile (not illustrated). The compressor 1 is mounted on an installation surface provided on a vehicle body. As illustrated in FIGS. 1 and 2, the compressor 1 is provided with a main body portion 10 for compressing a refrigerant and a soundproof cover 20 for covering the main body portion 10. The compressor 1 is an electric compressor driven by electricity supplied from an outside.

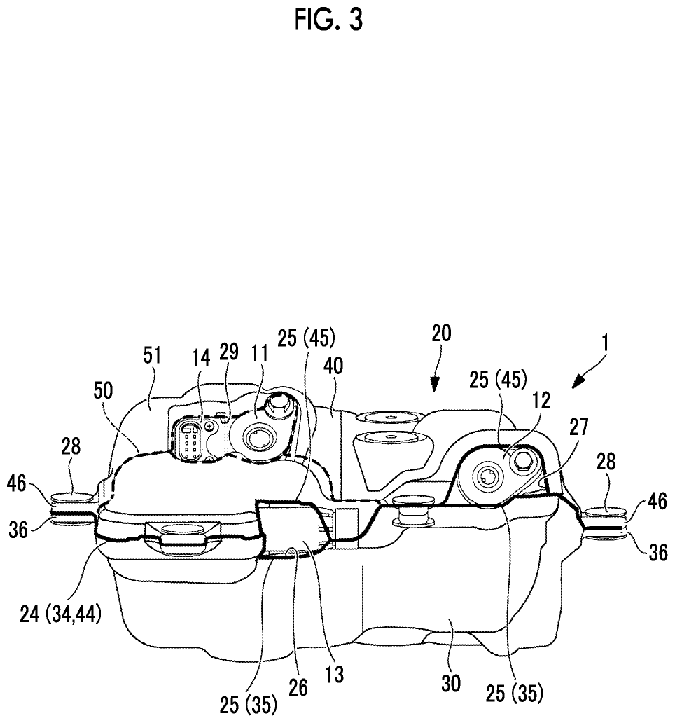

The main body portion 10 is provided with a compressor 1 for compressing the refrigerant (not illustrated), an electric motor for driving the compressor 1 (not illustrated), and a housing for accommodating the compressor 1 and the electric motor (not illustrated). In addition, as illustrated in FIG. 3, the main body portion 10 is provided with an intake port (connecting portion) 11 for supplying the refrigerant to the compressor 1, a discharge port (connecting portion) 12 for discharging the refrigerant compressed by the compressor 1 to the outside, a high-voltage socket (connecting portion) 13 to which a high-voltage cable (not illustrated) supplying high-voltage electricity to the electric motor is connected, and a low-voltage socket (connecting portion) 14 to which a low-voltage cable (not illustrated) supplying low-voltage electricity to the electric motor is connected.

The intake port 11 is connected to an intake pipe (not illustrated) that guides the refrigerant vaporized by an evaporator (not illustrated) to the compressor 1. The intake port 11 is provided so as to protrude outward from an outer peripheral surface of the housing. In addition, the discharge port 12 is connected to a discharge pipe (not illustrated) that guides the refrigerant compressed by the compressor 1 to a condenser (not illustrated). The intake port 11 is provided so as to protrude outward from an outer peripheral surface of the housing.

The soundproof cover 20 is made of a porous material of open cells having a density of 0.19 g/cm³ or less. The porous material of open cells is made of, for example, a urethane foam material. A method of producing the porous material of open cells is not particularly limited, and for example, the porous material is produced by allowing the bubbles to communicate with each other by applying pressure to the porous material of closed cells.

As illustrated in FIGS. 1 and 2, the soundproof cover 20 forms an internal space S inside. The main body portion 10 is accommodated inside the soundproof cover 20 (that is, internal space S). As illustrated in FIGS. 1 to 3, the soundproof cover 20 is vertically divided into a first cover (first part) 30 and a second cover (second part) 40 by a division part. That is, the soundproof cover 20 is provided with the first cover 30 that covers a lower portion of the main body portion 10, and the second cover 40 that covers an upper portion of the main body portion 10. The division part divides the soundproof cover 20 so as to cut the soundproof cover 20 on a surface along a horizontal plane. The division part is provided in substantially the entire circumferential direction of the soundproof cover 20. In addition, the division part is provided so as to pass through a first opening 26 and a second opening 27, which will be described later. The division part is illustrated by a thick line in FIG. 3.

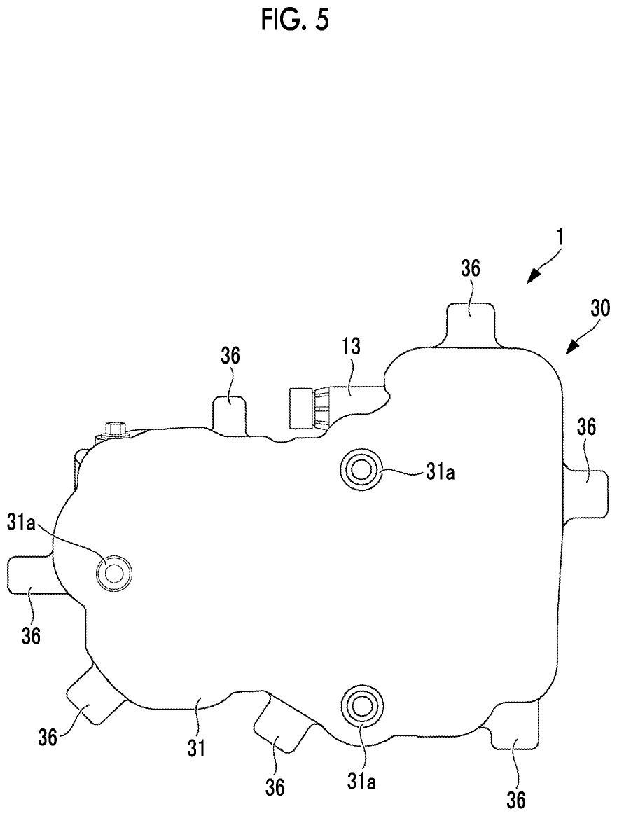

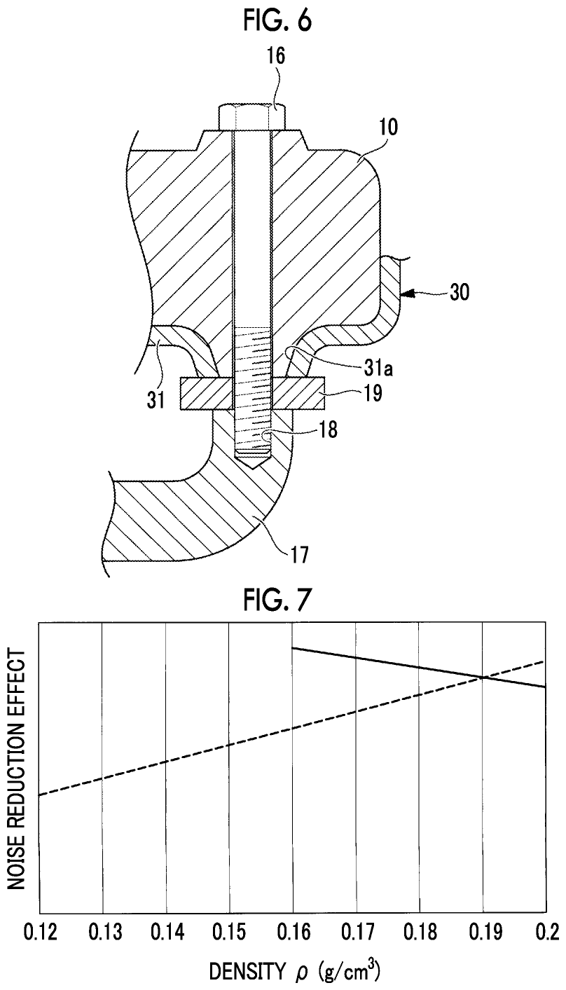

As illustrated in FIG. 2, the first cover 30 is disposed between the main body portion 10 and the installation surface of the vehicle body. The first cover 30 integrally includes a bottom surface part 31 that defines a lower end of the internal space S, a lower side surface part 32 that defines a lower portion of the side ends of the internal space S, and a plurality of lower fixing parts (cover fixing parts) 36 that protrude outward from an upper end of the lower side side surface part. In addition, as illustrated in FIGS. 5 and 6, a plurality of bolt insertion holes 31a (three in the present embodiment) are formed in the bottom surface part 31 of the first cover 30. A fixing bolt 16 (refer to FIG. 6) for fixing the main body portion 10 to the vehicle body side is inserted into each bolt insertion hole 31a. Each bolt insertion hole 31a penetrates the bottom surface part 31 in the vertical direction. The diameter of each bolt insertion hole 31a is slightly larger than the diameter of a shaft part of the fixing bolt (fixing member) 16.

As illustrated in FIG. 2, the lower side surface part 32 bends and extends upward from substantially the entire outer peripheral portion of the bottom surface part 31. An upper end surface 33 of the lower side surface part 32 is a division part. The upper end surface 33 of the lower side surface part 32 includes a lower abutment part 34 that abuts on an upper side surface part 42 of the second cover 40, which will be described later, and a lower spaced-apart portion 35 that is separated from the upper side surface part 42 of the second cover 40.

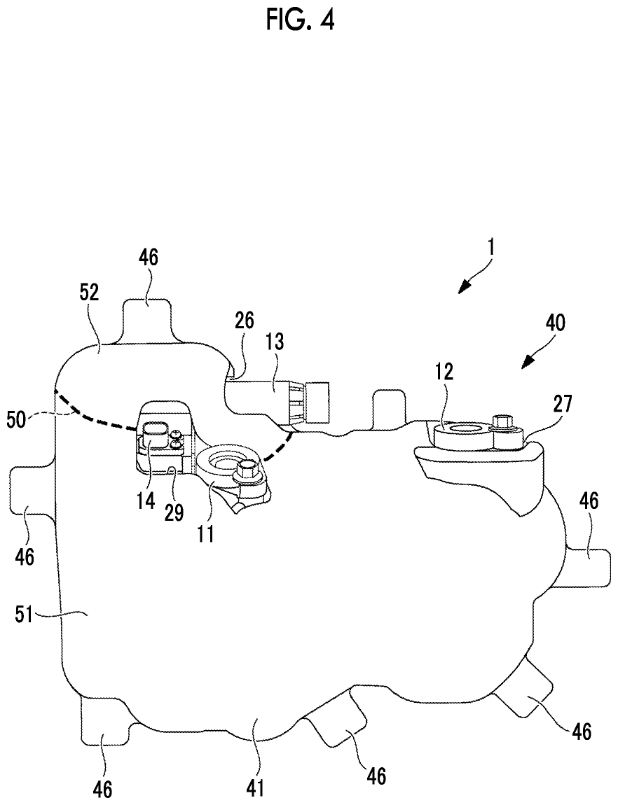

The second cover 40 is provided above the first cover 30. The second cover 40 includes integrally includes a upper surface part 41 that defines an upper end of the internal space S, an upper side surface part 42 that defines an upper portion of the side ends of the internal space S, and a plurality of upper fixing parts (cover fixing parts) 46 that protrude outward from a lower end of the upper side surface part 42. In addition, as illustrated in FIG. 4, the second cover 40 is formed with an opening through which the low-voltage socket 14 and the intake port 11 are inserted (hereinafter, referred to as “third opening 29”). The third opening 29 connects the internal space S of the soundproof cover 20 and the external space outside the soundproof cover 20. The low-voltage socket 14 and the intake port 11 are accessible to the external space by the third opening 29. A slight gap is formed between an edge of the third opening 29, the low-voltage socket 14, and the intake port 11.

The upper side surface part 42 bends and extends downward from substantially the entire outer peripheral portion of the upper surface part 41. The lower end surface 43 of the upper side surface part 42 is a division part. The lower end surface 43 of the lower side surface part 32 includes an upper abutment part 44 that abuts on the lower side surface part 32 of the first cover 30 and an upper spaced-apart portion 45 that is separated from the lower side surface part 32 of the first cover 30.

As illustrated in FIG. 2, the first cover 30 and the second cover 40 are disposed so that the upper end surface 33 of the lower side surface part 32 and the lower end surface 43 of the upper side surface part 42 face each other. Specifically, the first cover 30 and the second cover 40 are disposed so that the lower abutment part 34 of the lower side surface part 32 and the upper abutment part 44 of the upper side surface part 42 abut on each other. In addition, the first cover 30 and the second cover 40 are disposed so that the lower spaced-apart portion 35 of the lower side surface part 32 and the upper spaced-apart portion 45 of the upper side surface part 42 are separated from each other to form an opening.

As illustrated in FIG. 3, the soundproof cover 20 includes an abutment part 24 in which the lower abutment part 34 of the first cover 30 and the upper abutment part 44 of the second cover 40 abut on each other. The abutment part 24 separates the internal space S of the soundproof cover 20 and the external space outside the soundproof cover 20. In addition, the soundproof cover 20 includes a spaced-apart portion 25 in which the lower spaced-apart portion 35 of the first cover 30 and the upper spaced-apart portion 45 of the second cover 40 are separated from each other. The spaced-apart portion 25 forms an opening connecting the internal space S of the soundproof cover 20 and the external space outside the soundproof cover 20. In the present embodiment, the soundproof cover 20 includes two spaced-apart portions 25.

Each of the two spaced-apart portions 25 forms an opening. That is, the soundproof cover 20 includes two openings formed by the spaced-apart portion 25. A discharge port 12 is inserted through one opening (hereinafter, referred to as “first opening 26”). In other words, the discharge port 12 is accessible to the external space by the first opening 26. A slight gap is formed between an edge of the first opening 26 and an outer peripheral surface of the discharge port 12. That is, the soundproof cover 20 and the discharge port 12 are not in contact with each other.

In addition, a high-voltage socket 13 is inserted through one opening (hereinafter, referred to as “second opening 27”). The high-voltage socket 13 is accessible to the external space by the second opening 27. A slight gap is formed between an edge of the second opening 27 and the high-voltage socket 13. That is, the soundproof cover 20 and the high-voltage socket 13 are not in contact with each other.

The main body portion 10 of the compressor 1 and the vehicle body are fixed by a plurality of (three in the present embodiment) fixing bolts 16. Specifically, as illustrated in FIG. 6, the main body portion 10 of the compressor 1 is fixed to a fixing bracket 17 provided on the vehicle body side. A recessed portion 18 is formed in the fixing bracket 17. The fixing portion bolt penetrates the main body portion 10 and a tip is accommodated in the recessed portion 18 of the fixing bracket 17. The tip of the fixing bracket 17 and the recessed portion 18 are screwed with each other. In addition, the fixing bolt 16 is inserted through the bolt insertion hole 31a formed in the first cover 30 as described above. In addition, the first cover 30 is disposed between the main body portion 10 and the fixing bracket 17. In addition, a washer 19 is provided between the first cover 30 and the fixing bracket 17.

As illustrated in FIG. 3, the first cover 30 and the second cover 40 are fixed by fixing the lower fixing part 36 and the upper fixing part 46. The lower fixing part 36 and the upper fixing part 46 are fixed by a plurality of clips 28 penetrating each fixing part. The member for fixing the lower fixing part 36 and the upper fixing part 46 is not limited to the clip 28 (refer to FIG. 3). For example, the lower fixing part 36 and the upper fixing part 46 may be fixed by bolts, nuts, or the like.

Next, a method of assembling the compressor 1 will be described.

First, in a state where the first cover 30 is disposed between the main body portion 10 and the installation surface of the vehicle body, the main body portion 10 is fixed to the vehicle body by the fixing bolt 16. At this time, since the fixing bolt 16 penetrates the first cover 30, the first cover 30 is fixed to the vehicle body and the main body portion 10. Next, the main body portion 10 is covered with the second cover 40. At this time, the upper abutment part 44 of the second cover 40 abuts on the lower abutment part 34 of the first cover 30. In a state where the lower abutment part 34 and the upper abutment part 44 abut on each other, the lower fixing part 36 and the upper fixing part 46 are fixed by the clip 28 or the like. As described above, the compressor 1 is assembled in this manner.

According to the present embodiment, the following action and effect are exhibited.

In the present embodiment, the soundproof cover 20 includes the first cover 30 and the second cover 40. In other words, the soundproof cover 20 is divided into the first cover 30 and the second cover 40. In the soundproof cover 20 divided into the first cover 30 and the second cover 40, if a gap is formed in a part (division part) where the first cover 30 and the second cover 40 face each other due to a manufacturing error or the like, sound may leak from the gap. Therefore, it is desirable that the first cover 30 and the second cover 40 are in close contact with each other at the part (division part) facing each other.

In addition, the soundproof cover 20 is formed with openings (first opening 26 and second opening 27) through which members connected to the external device of the discharge port 12 and the high-voltage socket 13 are inserted. In a case where the gap formed between the edge of each opening, the discharge port 12, and the high-voltage socket 13 is large, sound may leak from the gap. Therefore, it is desirable that the first opening 26 and the second opening 27 are formed so that the gap formed between the first opening 26, the second opening 27, and the connecting portion is small. On the other hand, since the compressed refrigerant circulates inside the discharge port 12, the temperature is high. Therefore, when the high temperature discharge port 12 and the soundproof cover 20 (edge of the first opening 26) come into contact with each other, various problems such as damage to the soundproof cover 20 due to the heat of the discharge port 12 may occur. In addition, since high-voltage electricity circulates through the high-voltage socket 13, the temperature is high. Therefore, when the high-temperature high-voltage socket 13 and the soundproof cover 20 (edge of the second opening 27) come into contact with each other, various problems such as damage to the soundproof cover 20 due to the heat of the high-voltage socket 13 and short circuit may occur. Therefore, the first opening 26 and the second opening 27 are required to be formed so as not to come into contact with the discharge port 12 and the high-voltage socket 13.

As described above, it is desirable that the soundproof cover 20 is formed with high accuracy at the part where the first cover 30 and the second cover 40 face each other and the part where the openings (first opening 26 and second opening 27) through which the discharge port 12 and the high-voltage socket 13 are inserted are formed.

For example, in a case where an opening through which the discharge port 12 and the high-voltage socket 13 are inserted is formed in the first cover 30 or the second cover 40 as in the third opening 29 (refer to FIG. 3), it is necessary to form an opening separately from the part where the first cover 30 and the second cover 40 face each other. Therefore, it is necessary to form the part where the first cover 30 and the second cover 40 face each other with high accuracy, and to form the part where the opening is formed with high accuracy.

On the other hand, in the present embodiment, the first cover 30 and the second cover 40 are separated from each other to form openings (first opening 26 and second opening 27) through which the discharge port 12 and the high-voltage socket 13 are inserted. That is, the openings (first opening 26 and second opening 27) are formed in the part where the first cover 30 and the second cover 40 face each other. As a result, it is not necessary to form openings (first opening 26 and second opening 27) separately from the part where the first cover 30 and the second cover 40 face each other. Therefore, it is possible to reduce the number of parts formed with high accuracy. As a result, it is possible to simplify the manufacture of the soundproof cover 20.

In addition, in the present embodiment, the first cover 30 is disposed between the main body portion 10 and the vehicle body (fixing bracket 17), and the fixing bolt 16 for fixing the main body portion 10 to the vehicle body penetrates the first cover 30. As a result, by fixing the main body portion 10 to the vehicle body, the relative movement between the main body portion 10 and the first cover 30 is also regulated by the fixing bolt 16. Therefore, there is no need for a separate structure for fixing the first cover 30 and the main body portion 10. Therefore, the number of components of the compressor 1 can be reduced.

In addition, the first cover 30 is interposed between the main body portion 10 and the vehicle body (fixing bracket 17) located below the main body portion 10. As a result, since the first cover 30 is pressed against the vehicle body by the main body portion 10, the relative movement between the first cover 30 and the main body portion 10 is strongly regulated. Therefore, the first cover 30 can be made difficult to fall off from the main body portion 10. In addition, since the relative movement between the first cover 30 and the main body portion 10 is strongly regulated, the second cover 40 can be easily positioned with respect to the first cover 30. Therefore, the second cover 40 can be easily attached to the first cover 30.

In addition, in the present embodiment, the first cover 30 and the second cover 40 are fixed by the lower fixing part 36 and the upper fixing part 46 so that the soundproof cover 20 is regulated so as not to be separated from the main body portion 10. As a result, it is not necessary to directly fix the soundproof cover 20 to the main body portion 10. Therefore, the soundproof cover 20 can be regulated so as not to be separated from the main body portion 10 without providing a structure for fixing the soundproof cover 20 to the main body portion 10. Therefore, the soundproof cover 20 can be easily added to the existing main body portion 10.

In addition, in the present embodiment, the soundproof cover 20 is made of a porous material. When the sound generated in the main body portion 10 is transmitted to the soundproof cover 20, the air in the porous material vibrates. When the air in the porous material vibrates, the viscous resistance of the air causes friction between the porous material and the air. As a result, the sound energy input from the main body portion 10 is converted into thermal energy. As described above, the soundproof cover 20 can absorb the sound generated by the main body portion 10. Therefore, the soundproof cover 20 can reduce the noise generated in the main body portion 10.

In addition, under predetermined conditions, the porous material of open cells has a higher sound absorbing effect than the porous material of closed cells having the same density due to the increase in the viscous resistance of air. In the present embodiment, it is made of a porous material of open cells. Therefore, noise can be further reduced.

The predetermined conditions will be described in detail with reference to FIG. 7. In FIG. 7, a solid line illustrates the porous material of open cells, and a broken line illustrates the porous material of closed cells. In the porous material of open cells, the number of bubbles decreases as the density increases, and the sound absorbing effect decreases. Therefore, as illustrated in FIG. 7, the porous material of open cells tends to reduce a noise reducing effect as the density increases. On the other hand, the porous material of closed cells tends to increase the noise reducing effect as the density increases. As illustrated in FIG. 7, when the density is 0.19 g/cm³ or less, the porous material of open cells has a higher noise reducing effect than the porous material of closed cells. In the present embodiment, the density of the porous material of open cells is 0.19 g/cm³ or less. Therefore, the noise reducing effect can be improved as compared with the case of using a porous material of closed cells.

In addition, in general, the higher the density of a porous material, the more difficult the porous material is to mold. In the present embodiment, since the density is 0.19 g/cm³ or less, the soundproof cover 20 can be easily molded. In addition, since the density is 0.19 g/cm³ or less, the weight of the soundproof cover 20 can be reduced.

### Modification Example

The second cover 40 may be further divided into two parts. Specifically, the second cover 40 may include a first division cover 51 and a second division cover 52. That is, the soundproof cover 20 may be divided into three parts. As illustrated in FIGS. 3 and 4, the division part 50 (broken line in FIGS. 3 and 4) for dividing the first division cover 51 and the second division cover 52 is provided so as to pass through the third opening 29. That is, the third opening 29 is formed between the first division cover 51 and the second division cover 52. The division part 50 of the present modification example is a part where an end surface of the first division cover 51 on the second division cover 52 side and an end surface of the second division cover 52 on the first divided side face each other.

In present modification example, since the second cover 40 is further divided, each component constituting the cover can be miniaturized. Therefore, each component can be easily transported. In addition, the cover can be easily attached to the main body portion 10.

In addition, in present modification example, the third opening 29 is formed between the first division cover 51 and the second division cover 52. As a result, it is not necessary to form an opening through which the intake port 11 and the low-voltage socket 14 are inserted, separately from the part where the first division cover 51 and the second division cover 52 face each other. Therefore, it is possible to reduce the number of parts formed with high accuracy. As a result, it is possible to simplify the manufacture of the soundproof cover 20.

### Second Embodiment

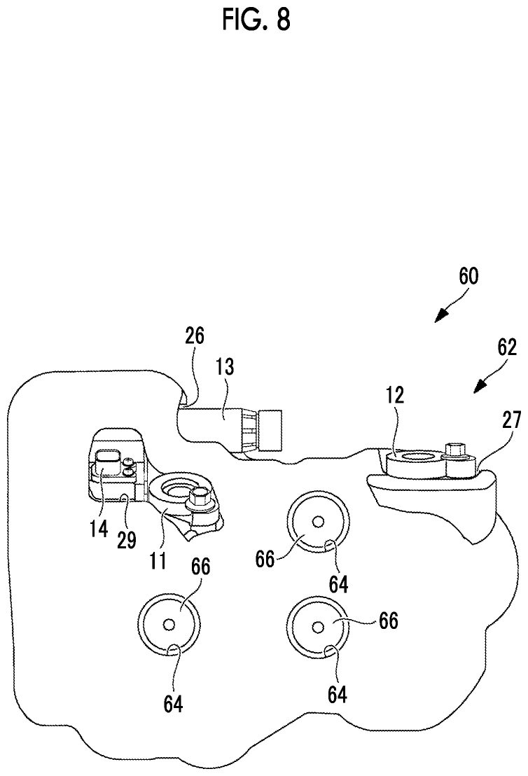

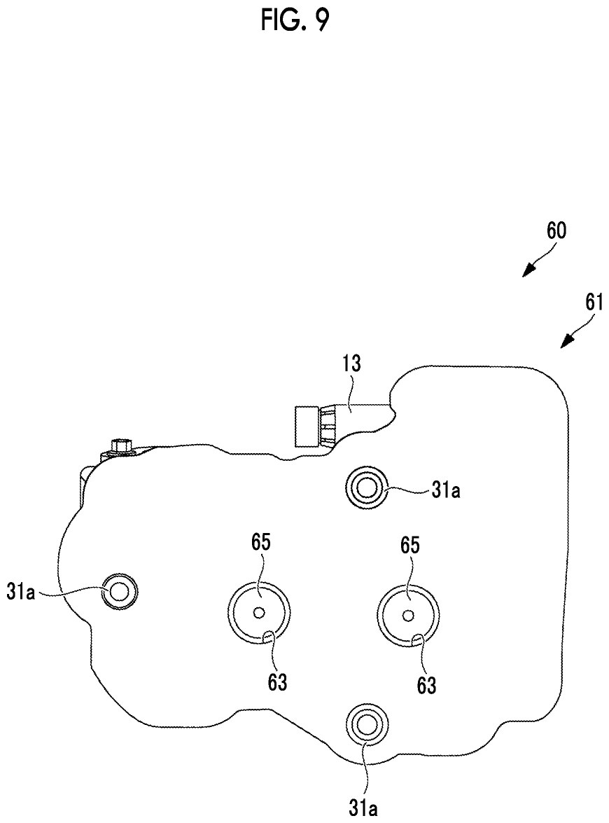

Next, a second embodiment of the present disclosure will be described with reference to FIGS. 8 and 9.

The soundproof cover 60 of the present embodiment is different from the first embodiment in that the first cover 61 and the second cover 62 are not fixed, and each of the first cover 61 and the second cover 62 is fixed to the main body portion 10. The same components as those in the first embodiment are designated by the same reference numerals, and detailed description thereof will be omitted.

As illustrated in FIG. 9, the first cover 61 according to the present embodiment does not include the lower fixing part 36. A plurality of (two as an example in the present embodiment) first through-holes 63 are formed in the first cover 61. The first through-hole 63 is formed in the bottom surface part 31 of the first cover 61. A bolt (not illustrated) is inserted through the first through-hole 63. The tip of the bolt is screwed into the main body portion 10. A first washer 65 is provided between a head of the bolt and the first cover 61. By fastening the bolt to the main body portion 10, the first cover 61 is fixed to the main body portion 10.

As illustrated in FIG. 8, the second cover 62 according to the present embodiment does not include the upper fixing part 46. A plurality of (three as an example in the present embodiment) second through-holes 64 are formed in the second cover 62. The second through-hole 64 is formed in the upper surface part 41 of the second cover 62. A bolt (not illustrated) is inserted through the second through-hole 64. The tip of the bolt is screwed into the main body portion 10. A second washer 66 is provided between the head of the bolt and the second cover 62. By fastening the bolt to the main body portion 10, the second cover 62 is fixed to the main body portion 10.

For example, in a case where the first cover 61 and the second cover 62 are fixed by a fixing part or the like protruding outward from the housing as in the first embodiment, the outer shape of the soundproof cover 60 is increased by the part provided with the fixing part.

On the other hand, in the present embodiment, the soundproof cover 60 is directly fixed to the main body portion 10. As a result, it is not necessary to provide a fixing part or the like. Therefore, the outer shape of the soundproof cover 60 can be reduced as compared with the structure in which the fixing parts are provided on the first cover 61 and the second cover 62. Therefore, since the compressor 1 can be miniaturized, it is possible to prevent the compressor 1 from interfering with other components.

The present disclosure is not limited to the configuration of each of the above embodiments, may be changed or improved as appropriate without departing from the gist of the present disclosure, and the embodiment in which such changes or improvements are made are also included in the scope of rights of the present disclosure.

For example, in each of the above embodiments, an example in which the compression mechanism is driven by an electric motor has been described, but the present disclosure is not limited thereto. For example, the compression mechanism may be driven by the driving force of the traveling engine without providing the electric motor for driving the compression mechanism. In this case, the electric motor, the high-voltage socket 13, and the low-voltage socket 14 do not exist. Therefore, the division part passes only through the first opening 26 through which the discharge port 12 is inserted.

In addition, in each of the above embodiments, an example in which the soundproof cover 20 is made of the porous material of open cells has been described, but the present disclosure is not limited thereto. For example, the soundproof cover 20 may be made of a porous material of closed cells.

In addition, in each of the above embodiments, an example in which the soundproof cover 20 is divided into two or three has been described, but the present disclosure is not limited thereto. For example, the soundproof cover 20 may be divided into four or more.

The compressor 1 described in each of the above-described embodiments is grasped as follows, for example.

A compressor according to an aspect of the present disclosure is a compressor (1) provided in an air conditioning device for an automobile, including a main body portion (10) that includes a connecting portion (12, 13) connecting to an external device and compresses a refrigerant, and a soundproof cover (20) that includes a first part (30) and a second part (40) separate from the first part, has an internal space (S) formed inside the soundproof cover, and accommodates the main body portion in the internal space (S), in which the soundproof cover includes an abutment part (24) that separates the internal space from an external space outside the soundproof cover by abutting the first part and the second part, and a spaced-apart portion (25) that forms an opening (26) connecting the internal space and the external space by separating the first part and the second part, in a part where the first part and the second part face each other, and the connecting portion is inserted through the opening.

In the above configuration, the soundproof cover includes the first part and the second part. In other words, the soundproof cover is divided into the first part and the second part. In the soundproof cover divided into the first part and the second part, if a gap is formed in the part where the first part and the second part face each other due to a manufacturing error or the like, sound may leak from the gap. Therefore, it is desirable that the first part and the second part are in close contact with each other at the parts facing each other. In addition, the soundproof cover accommodating the main body portion including the connecting portion connected to the external device needs to form the opening through which the connecting portion is inserted. In a case where a gap formed between an edge of the opening and the connecting portion is large, sound may leak through the gap. Therefore, it is desirable that the opening is formed so that the gap formed between the opening and the connecting portion is small. As described above, it is desirable that the soundproof cover is formed with high accuracy at the part where the first part and the second part face each other and the part where the opening through which the connecting portion is inserted is formed.

For example, in a case where the opening through which the connecting portion is inserted is formed in the first part or the second part, it is necessary to form an opening separately from a part facing the first part and the second part. On the other hand, in the above configuration, the first part and the second part are separated from each other to form the opening through which the connecting portion is inserted. That is, the opening is formed in the part where the first part and the second part face each other. As a result, it is not necessary to form an opening separately from the part facing the first part and the second part. Therefore, it is possible to reduce the number of parts formed with high accuracy. As a result, it is possible to simplify the manufacture of the soundproof cover.

The main body portion includes a compression mechanism that compresses the refrigerant, the housing that accommodates the compression mechanism, and the like.

In addition, in the compressor according to an aspect of the present disclosure, the connecting portion includes a discharge port (12) that guides the refrigerant compressed by the main body portion to an outside.

In the above configuration, the discharge port is inserted through the opening. Since the compressed refrigerant circulates inside the discharge port, the temperature is high. Therefore, when the high temperature discharge port and the soundproof cover come into contact with each other, various problems such as damage to the soundproof cover due to the heat of the discharge port may occur. Therefore, there is a higher need to form the opening with high accuracy. In the above configuration, the first part and the second part are separated from each other to form the opening through which the connecting portion is inserted. Therefore, it is possible to reduce the number of parts formed with high accuracy. As a result, it is possible to simplify the manufacture of the soundproof cover.

In addition, in the compressor according to an aspect of the present disclosure, the connecting portion includes a high-voltage socket (13) that supplies electric power from the outside to the main body portion.

In the above configuration, a high-voltage socket is inserted through the opening. Since high-voltage electricity circulates through the high-voltage socket, the temperature is high. Therefore, when between the high-temperature high-voltage socket and the soundproof cover come into contact with each other, various problems such as damage to the soundproof cover due to the heat of the high-voltage socket and short circuit may occur. Therefore, there is a higher need to form the opening with high accuracy. In the above configuration, the first part and the second part are separated from each other to form the opening through which the connecting portion is inserted. Therefore, it is possible to reduce the number of parts formed with high accuracy. As a result, it is possible to simplify the manufacture of the soundproof cover.

In addition, in the compressor according to an aspect of the present disclosure, the compressor further includes a fixing member (16) that fixes the main body portion to a vehicle body, in which the first part is disposed between the main body portion and the vehicle body located below the main body portion, and the fixing member penetrates the first part.

In the above configuration, the first part is disposed between the main body portion and the vehicle body, and the fixing member that fixes the main body portion to the vehicle body penetrates the first part. As a result, by fixing the main body portion to the vehicle body, the relative movement between the main body portion and the first part is also regulated by the fixing member. Therefore, there is no need for a separate structure for fixing the first part and the main body portion. Therefore, the number of components can be reduced.

In addition, the first part is interposed between the main body portion and the vehicle body located below the main body portion. As a result, since the first part is pressed against the vehicle body side by the main body portion, the relative movement between the first part and the main body portion is strongly regulated. Therefore, the first part can be made difficult to fall off from the main body portion. In addition, since the relative movement between the first part and the main body portion is strongly regulated, the second part can be easily positioned with respect to the first part. Therefore, the second part can be easily attached to the first part.

In addition, in the compressor according to an aspect of the present disclosure, the soundproof cover is fixed to the main body portion.

For example, by fixing the first part and the second part with flange portions or the like provided on the first part and the second part, the relative movement between the soundproof cover and the main body portion may be regulated. In this case, the outer shape of the soundproof cover is increased by the part provided with the flange portion.

On the other hand, in the above configuration, the soundproof cover is directly fixed to the main body portion. As a result, it is not necessary to provide a flange portion or the like. Therefore, the outer shape of the soundproof cover can be reduced as compared with the structure in which the flange portions are provided in the first part and the second part. Therefore, since the compressor can be miniaturized, it is possible to prevent the compressor from interfering with other components.

In addition, in the compressor according to an aspect of the present disclosure, the soundproof cover includes cover fixing parts (36, 46) that fix the first part and the second part.

In the above configuration, the first part and the second part are fixed by the cover fixing part to regulate the soundproof cover so as not to be separated from the main body portion. As a result, it is not necessary to directly fix the soundproof cover to the main body portion. Therefore, the soundproof cover can be regulated so as not to be separated from the main body portion without providing a structure for fixing the soundproof cover to the main body portion. Therefore, the soundproof cover can be easily added to the existing main body portion.

In addition, in the compressor according to an aspect of the present disclosure, the soundproof cover is made of a porous material.

In the above configuration, the soundproof cover is made of the porous material. When the sound generated in the main body portion is transmitted to the soundproof cover, the air in the porous material vibrates. When the air in the porous material vibrates, the viscous resistance of the air causes friction between the porous material and the air. As a result, the sound energy input from the main body portion is converted into thermal energy. As described above, the soundproof cover can absorb the sound generated in the main body portion. Therefore, the soundproof cover can reduce the noise generated in the main body portion.

Examples of the porous material include urethane foam material and the like.

In addition, in the compressor according to an aspect of the present disclosure, the porous material has a material of open cells having a density of 0.19 g/cm³ or less.

Under predetermined conditions, the porous material of open cells has a higher sound absorbing effect than the porous material of closed cells having the same density due to the increase in the viscous resistance of air. In the above configuration, it is made of a porous material of open cells. Therefore, noise can be further reduced.

On the other hand, as the density of the porous material of open cells increases, the number of bubbles decreases, so that the sound absorbing effect decreases. In the above configuration, the density of the porous material of open cells is 0.19 g/cm³ or less, which is the density at which a predetermined sound absorbing effect can be obtained. As a result, a predetermined sound absorbing effect can be obtained. In addition, in general, the higher the density of a porous material, the more difficult the porous material is to mold. In the above configuration, since the density is 0.19 g/cm³ or less, the soundproof cover can be easily molded.

### REFERENCE SIGNS LIST

1: compressor
10: main body portion
11: intake port
12: discharge port (connecting portion)
13: high-voltage socket (connecting portion)
14: low-voltage socket
16: fixing bolt (fixing member)
17: fixing bracket
18: recessed portion
19: washer
20: soundproof cover
24: abutment part
25: spaced-apart portion
26: first opening
27: second opening
28: clip
29: third opening
30: first cover (first part)
31: bottom surface part
31a: bolt insertion hole
32: lower side surface part
33: upper end surface
34: lower abutment part
35: lower spaced-apart portion
36: lower fixing part (cover fixing part)
40: second cover (second part)
41: upper surface part
42: upper side surface part
43: lower end surface
44: upper abutment part
45: upper spaced-apart portion
46: upper fixing part (cover fixing part)
50: division part
51: first division cover
52: second division cover
60: soundproof cover
61: first cover
62: second cover
63: first through-hole
64: second through-hole
65: first washer
66: second washer
S: internal space

1. A compressor provided in an air conditioning device for an automobile, comprising:
a main body portion that includes a connecting portion for connecting to an external device and compresses a refrigerant; and
a soundproof cover that includes a first part and a second part separate from the first part, has an internal space formed inside the soundproof cover, and accommodates the main body portion in the internal space, wherein
the soundproof cover includes an abutment part that separates the internal space from an external space outside the soundproof cover by causing the first part and the second part to abut on each other, and a spaced-apart portion that forms an opening connecting the internal space and the external space by separating the first part and the second part from each other, in a part where the first part and the second part face each other, and
the connecting portion is inserted through the opening.

2. The compressor according to claim 1, wherein
the connecting portion includes a discharge port that guides the refrigerant compressed by the main body portion to an outside.

3. The compressor according to claim 1, wherein
the connecting portion includes a high-voltage socket that supplies electric power from an outside to the main body portion.

4. The compressor according to claim 1, further comprising:
a fixing member that fixes the main body portion to a vehicle body, wherein
the first part is disposed between the main body portion and the vehicle body located below the main body portion, and
the fixing member penetrates the first part.

5. The compressor according to claim 1, wherein
the soundproof cover is fixed to the main body portion.

6. The compressor according to claim 1, wherein
the soundproof cover includes a cover fixing part that fixes the first part and the second part.

7. The compressor according to claim 1, wherein
the soundproof cover is made of a porous material.

8. The compressor according to claim 7, wherein
the porous material has a material of open cells having a density of 0.19 g/cm³ or less.
